(19) United States
(12) Patent Application Publication
(10) Pub. No.: US 2012/0133149 A1
(43) Pub. Date: May 31, 2012

(54) WIND TURBINE DEVICE

(76) Inventor: Stefan IOANA, Germantown, MD (US)

(21) Appl. No.: 13/366,287

(22) Filed: Feb. 4, 2012

Related U.S. Application Data
(63) Continuation of application No. 12/177,889, filed on Jul. 23, 2008, now abandoned.

(51) Int. Cl. F03D 9/00

(52) U.S. Cl. 290/55

(57) ABSTRACT

A wind turbine device that includes a three helix mono block blade rotor with a first blade, a second blade, a third blade, a central axis rotor and a vertical axis, a generator which provides current, a gearbox that amplifies movement of the rotor to the generator and a photo voltaic panel to produce current in an absence of wind by receiving sunlight and converting solar energy from the sunlight into electrical energy. The device also includes a tripod or tower support frame which mounts the rotor, a concrete base that mounts the tripod or tower support frame, a ground surface where concrete base is disposed and a utility grid connection or more batteries that receives the provided current. Various other arrangements of the wind turbine devices are also disclosed.

This application claims the benefit of U.S. Provisional Patent Application Ser. No. 60/952,220 filed Jul. 26, 2007 the entire disclosure of which is incorporated herein by reference. The present application is a continuation of U.S. Non-Provisional Patent Application Ser. No. 12/177,889 filed on Jul. 26, 2008, the entire disclosure of which is incorporated herein by reference.

### TECHNICAL FIELD & BACKGROUND

The present invention generally relates to a vertical axle helix mono block wind turbine device. More specifically, the present invention relates to a wind turbine device that is also called Marilyn or Flower Power that is mounted on a tripod, self standing tower or any vertical axle stand.

The present invention has a main element of the invention that is the rotor of the wind turbine itself. The rotor, also called Marilyn or Flower Power, is a required element and is mounted on a tripod, self-standing tower or any vertical axle standing. The vertical axle, tripod, mounting tower, concrete base pole, represents the base of the wind turbine device element. The present invention is a gearbox assembly that amplifies the movement of rotor to current generator. The permanent magnet generator provides current. A separate photovoltaic panel or flexible photovoltaic film mounted on rotor surface provides current in absence of the wind. The vertical axle helix mono block or VAHM wind turbine device generates current by transforming the wind energy, through the rotor via a permanent magnet generator to utility grid or charging the batteries.

### BRIEF DESCRIPTION OF THE DRAWINGS

The present invention will be described by way of exemplary embodiments, but not limitations, illustrated in the accompanying drawings in which like references denote similar elements.

FIG. 1 illustrates a front view of a wind turbine device, in accordance with one embodiment of the present invention.

FIG. 2 illustrates a front view of a pair of wind turbine devices in series, in accordance with one embodiment of the present invention.

FIG. 3 illustrates a diagram of a plurality of rooftop wind turbine devices in series, in accordance with one embodiment of the present invention.

FIG. 4 illustrates a diagram of an energy tree utilizing a plurality of rooftop wind turbine devices, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

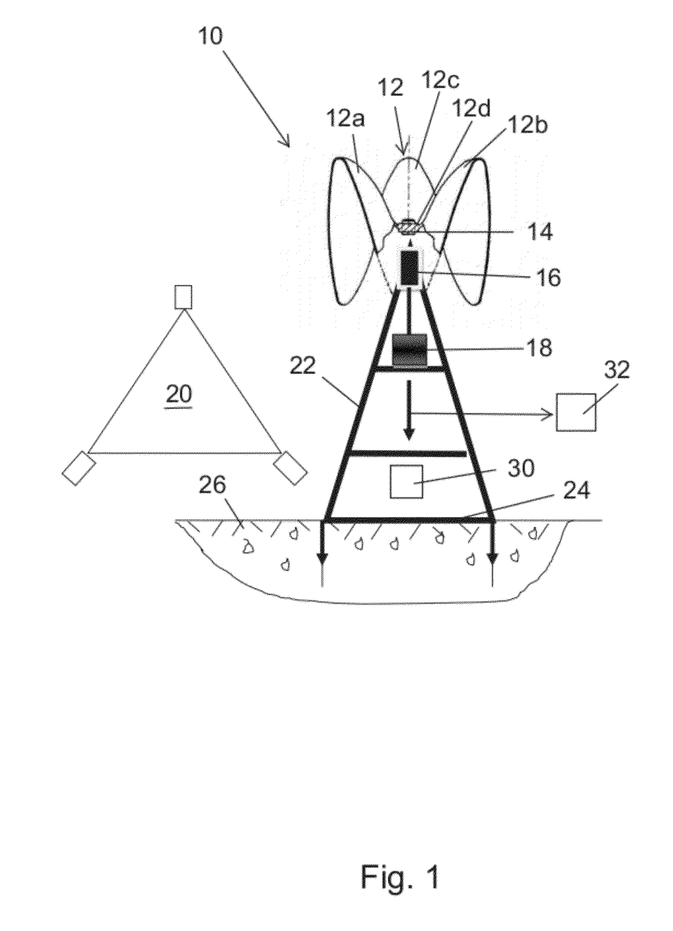

FIG. 1 illustrates a front view of a wind turbine device 10, in accordance with one embodiment of the present invention.

The wind turbine device 10 includes a three helix mono block blade rotor 12 with a first blade 12a, a second blade 12b, a third blade 12c, a central axis rotor 12d, a vertical axle 14, a gearbox 16, a permanent magnet generator 18, a photovoltaic panel or flexible photovoltaic film mounted on rotor surface 20, a tripod support frame 22, a concrete base 24, a ground surface 26 and one or more batteries 30.

The wind turbine device 10 has a relatively low speed rotor technology design with a large power coefficient. The wind turbine device 10 is cost effective to develop wind energy production to urban, suburban and rural markets. The first blade 12a, the second blade 12b and the third blade 12c have a helix type rotor and a central axis rotor 12d to form the three helix mono block blade rotor 12, which transforms wind energy into electrical energy, typically to utility grid 32 or one or more standalone batteries 30. The three helix mono block blade rotor 12 movement begins at an approximate 1-2 m/s wind speed and provides a self-braking momentum at over an approximate 17 m/s wind speed. The three helix mono block blade rotor 12 limits rotor revolutions to approximately 150 RPMs. This ensures protection of mechanical and electrical elements of the wind turbine device 10 at relatively high wind speeds. The three helix mono block blade rotor 12 is made of mono block fiberglass but can be made from other suitable materials as well. The wind turbine device 10 generates current by transforming wind energy through the three helix mono block blade rotor 12 to a utility grid 32 or one or more batteries 30. The 3 helix mono block blade rotor 12 is mounted to a tripod support frame 22 or other suitable tower which is mounted to a concrete base 24. The gearbox assembly 16 amplifies the movement of the rotor to generator 18 which provides current. The photovoltaic panel or flexible photovoltaic film mounted on rotor surface 20 will produce current in an absence of wind by receiving sunlight and converting the solar energy from the sunlight into electrical energy as well.

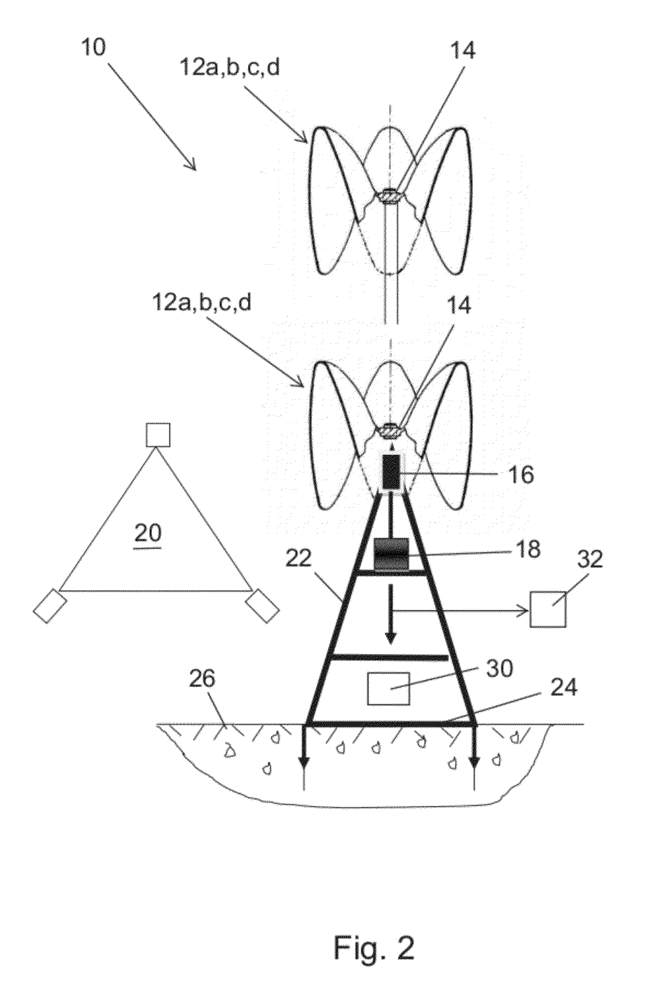

FIG. 2 illustrates a front view of a pair of wind turbine devices 10 in series, in accordance with one embodiment of the present invention. The wind turbine devices 10 have similar components and to the components illustrated and described in FIG. 1 and its description and include a three helix mono block blade rotor 12 with a first blade 12a, a second blade 12b, a third blade 12c, a central axis rotor 12d, a vertical axle 14, a gearbox 16, a permanent magnet current generator 18, a photovoltaic panel or flexible photovoltaic film mounted on rotor surface 20, a tripod support frame 22, a ground surface 26 and one or more batteries 30 or utility grid 32.

In contrast to the wind turbine device 10 described and outlined in FIG. 1, FIG. 2 simply has a second three helix mono block blade rotor 12 to create relatively more energy than the wind turbine device 10 described in FIG. 1 with only one three helix mono block blade rotor 12.

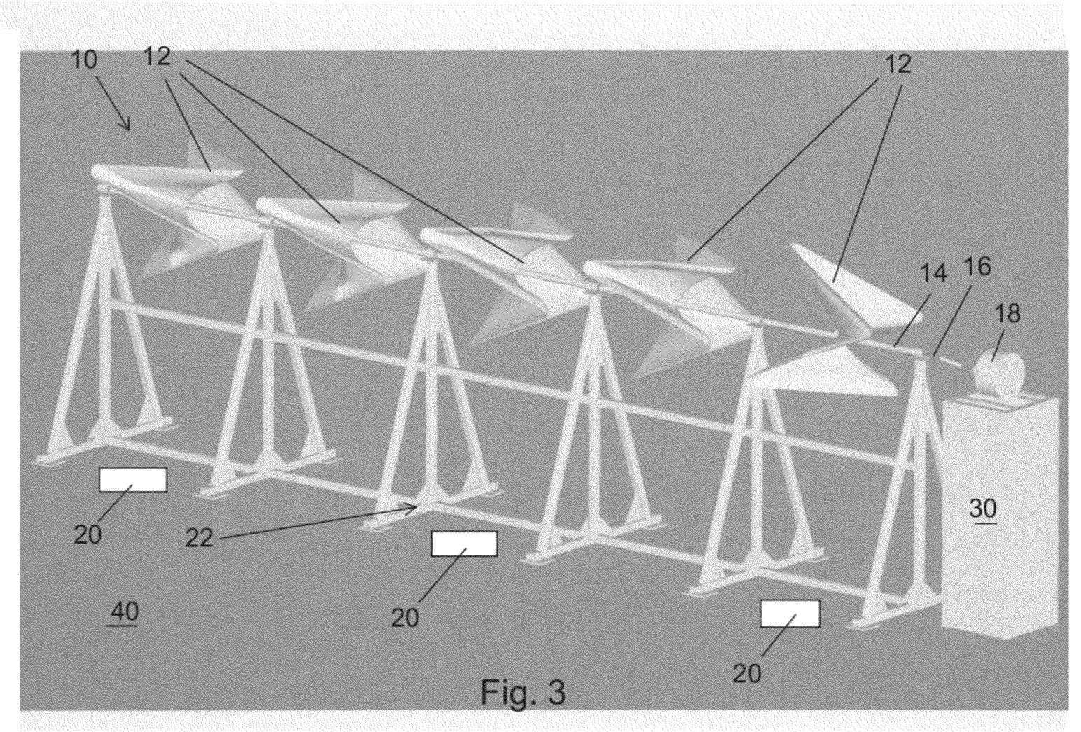

FIG. 3 illustrates a diagram of a plurality of wind turbine devices 10 in series disposed on a rooftop 40 of a building, in accordance with one embodiment of the present invention. The wind turbine devices 10 have similar components and to the components illustrated and described in FIG. 1 and its description and include a three helix mono block blade rotor 12, a vertical axle 14, a gearbox 16, a permanent magnet current generator 18 and a plurality of photovoltaic panels or flexible photovoltaic film mounted on rotor surface 20. In contrast to FIG. 1, FIG. 3 does not have a tripod support frame 22, a concrete base 24 or a ground surface 26. 6 three helix mono block blade rotors 12 are illustrated in a row in a 20 KW power arrangement that would typically be disposed on a rooftop 40 of an office building, condo, commercial building or other suitable building. Any other suitable building or quantity of power arrangement can also be utilized with the plurality of wind turbine devices 10 in series disposed on a rooftop 40 of a suitable building.

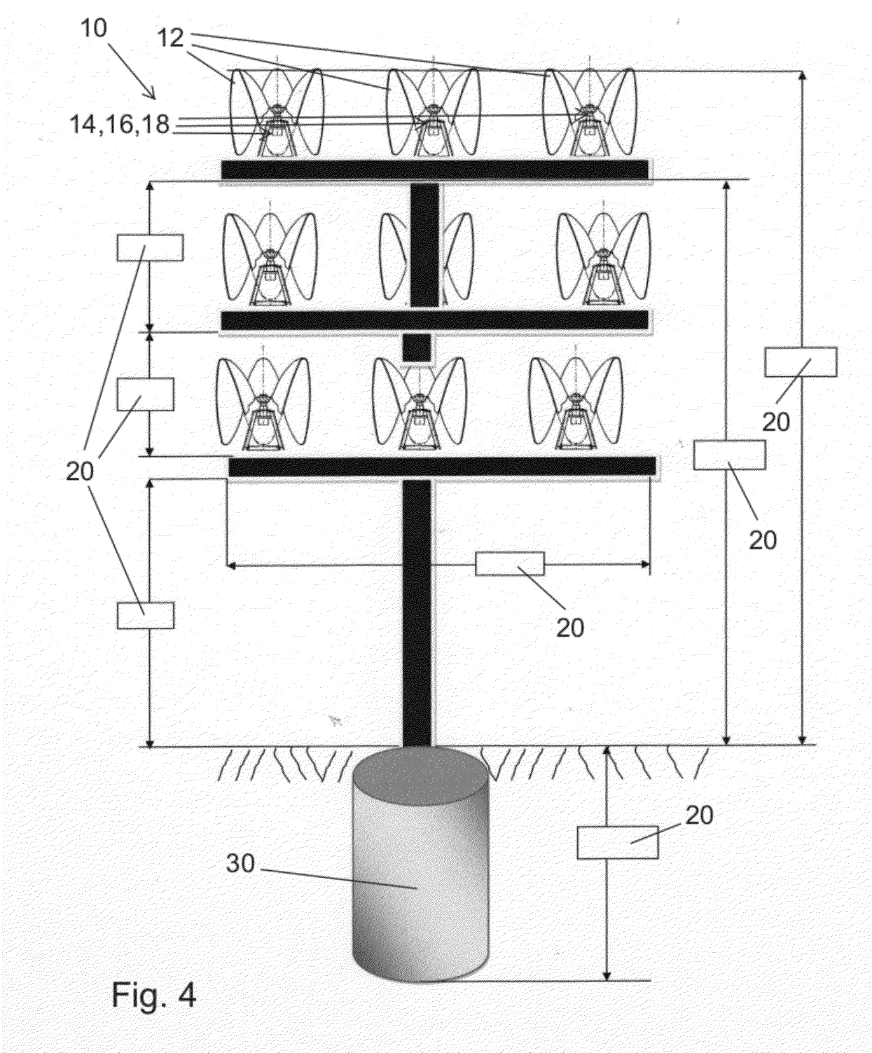

FIG. 4 illustrates a diagram of an energy tree 50 utilizing a plurality of rooftop wind turbine devices 10, in accordance with one embodiment of the present invention. The wind turbine devices 10 have similar components and to the components illustrated and described in FIG. 1 and its description and include a three helix mono block blade rotor 12, a vertical axle 14, a gearbox 16, a permanent magnet generator 18 and a plurality of photovoltaic panels or flexible photovoltaic film mounted on rotor surface 20. In contrast to FIG. 1, FIG. 4 does not have a tripod support frame 22, a concrete base 24 or a ground surface 26. FIG. 4 illustrates 9 three helix mono block blade rotors 12 are illustrated in a 3 row×3 column 30 KW power arrangement. The 9 three helix mono block blade rotors 12 are providing energy to utility grid 32 or one or more batteries 30 disposed at the bottom of the energy tree 50. The 9 three helix mono block blade rotors 12 have similar components to the three helix mono block blade rotors 12 illustrated and described in FIGS. 1, 2 and 3.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A wind turbine device, comprising:
a three helix mono block blade rotor with a first blade, a second blade, a third blade, a central axis rotor and a vertical axis;
a permanent magnet generator which provides current;
a gearbox that amplifies movement of said rotor to said generator;
a separate photovoltaic panel or flexible photovoltaic film to produce current in an absence of wind by receiving sunlight and converting solar energy from said sunlight into electrical energy;
a tripod support frame which mounts said rotor;
a concrete base that mounts said tripod support frame;
a ground surface where concrete base is disposed; and
a utility grid or one or more batteries that receives said provided current.

2. The device of claim 1, wherein said device rotor movement begins at an approximate 1 to 2 m/s wind speed.

3. The device of claim 1, wherein said device self-breaking momentum is provided at a wind speed at over approximately 17 m/s.

4. The device of claim 1, wherein said three helix mono block blade rotor limits rotor revolutions to approximately 150 RPMs to ensure protection of one or more mechanical and electrical elements of said wind turbine device at high wind speed.

5. The device according to claim 1, wherein said device has a low speed rotor technology design.

6. The device according to claim 1, wherein said device has a large power coefficient.

7. The device according to claim 1, wherein a pair of said wind turbine devices are combined in series.

8. A plurality of wind turbine devices in series disposed on a rooftop of a building, comprising:
a plurality of three helix mono block blade rotors with a first blade, a second blade, a third blade, a central axis rotor and a vertical axis;
a vertical axle utilized with each said three helix mono block blade rotor;
a gearbox that amplifies movement of said rotor to said generator utilized with each said three helix mono block blade rotor;
a permanent magnet generator which provides current that is utilized with each said three helix mono block blade rotor;
a plurality of photovoltaic panels or flexible photovoltaic film mounted on rotor surface to produce current in an absence of wind by receiving sunlight and converting solar energy from said sunlight into electrical energy; and
a utility grid or one or more batteries that receives said provided current.

9. The device of claim 8, wherein said device rotor movement begins at an approximate 1 to 2 m/s wind speed.

10. The device of claim 8, wherein said device self-braking momentum is provided at a wind speed at over approximately 17 m/s.

11. The device of claim 8, wherein said three helix mono block blade rotor limits rotor revolutions to approximately 150 RPMs to ensure protection of one or more mechanical and electrical elements of said wind turbine device at high wind speed.

12. The device according to claim 8, wherein said rotor is made of fiberglass.

13. The device according to claim 8, wherein 6 said three helix mono block blade rotors are illustrated in a row in a 20 KW power arrangement.

14. The device according to claim 8, wherein said devices have a low speed rotor technology design and a large power coefficient.

15. An energy tree with a bottom utilizing a plurality of rooftop wind turbine devices, comprising:
9 fiberglass three helix mono block blade rotors in a 3 row×3 column 30 KW power arrangement providing energy to a utility grid one or more batteries disposed at said bottom of said energy tree;
a vertical axle utilized with each said three helix mono block blade rotor;
a gearbox that amplifies movement of each said rotor to said generator utilized with each said three helix mono block blade rotor;
a permanent magnet generator which provides current that is utilized with each said three helix mono block blade rotor; and
a plurality of photovoltaic panels or flexible photovoltaic film mounted on rotor surface or to produce current in an absence of wind by receiving sunlight and converting solar energy from said sunlight into electrical energy.

16. The device of claim 15, wherein said device rotor movement begins at an approximate 1 to 2 m/s wind speed.

17. The device of claim 15, wherein said device self-braking momentum is provided at a wind speed at over approximately 17 m/s.

18. The device of claim 15, wherein said 9 three helix mono block blade rotors limits rotor revolutions to approximately 150 RPM to ensure protection of one or more mechanical and electrical elements of said wind turbine device at high wind speed.

19. The device according to claim 15, wherein said rotor is made of fiberglass.

20. The device according to claim 15, wherein said device has a low speed rotor technology design and a large power coefficient.
